(19) United States
(12) Patent Application Publication
(10) Pub. No.: US 2024/0223615 A1
(43) Pub. Date: Jul. 4, 2024

(54) SYSTEM AND METHOD FOR DATA SET CREATION WITH CROWD-BASED REINFORCEMENT

(71) Applicant: QOMPLX LLC, Reston, VA (US)

(72) Inventors: Jason Crabtree, Vienna, VA (US); Andrew Sellers, Monument, CO (US)

(21) Appl. No.: 18/437,238

(22) Filed: Feb. 8, 2024

Related U.S. Application Data
(63) Continuation of application No. 17/001,459, filed on Aug. 24, 2020.
Application No. 17/001,459 is a continuation-in-part of application No. 16/983,233, filed on Aug. 3, 2020, now abandoned.
Application No. 16/983,233 is a continuation-in-part of application No. 15/931,534, filed on May 13, 2020, now abandoned.
Application No. 15/931,534 is a continuation-in-part of application No. 16/777,270, filed on Jan. 30, 2020, now Pat. No. 11,025,674.
Application No. 16/777,270 is a continuation-in-part of application No. 16/720,383, filed on Dec. 19, 2019, now Pat. No. 10,944,795.
Application No. 16/720,383 is a continuation of application No. 15/823,363, filed on Nov. 27, 2017, now Pat. No. 10,560,483.
Application No. 15/823,363 is a continuation-in-part of application No. 15/725,274, filed on Oct. 4, 2017, now Pat. No. 10,609,079.
Application No. 15/725,274 is a continuation-in-part of application No. 15/655,113, filed on Jul. 20, 2017, now Pat. No. 10,735,456.
Application No. 15/655,113 is a continuation-in-part of application No. 15/616,427, filed on Jun. 7, 2017, now abandoned.
Application No. 15/616,427 is a continuation-in-part of application No. 14/925,974, filed on Oct. 28, 2015, now abandoned.
Application No. 15/655,113 is a continuation-in-part of application No. 15/237,625, filed on Aug. 15, 2016, now Pat. No. 10,248,910.
Application No. 15/237,625 is a continuation-in-part of application No. 15/206,195, filed on Jul. 8, 2016, now abandoned.
Application No. 15/206,195 is a continuation-in-part of application No. 15/186,453, filed on Jun. 18, 2016, now abandoned.
Application No. 15/186,453 is a continuation-in-part of application No. 15/166,158, filed on May 26, 2016, now abandoned.
Application No. 15/166,158 is a continuation-in-part of application No. 15/141,752, filed on Apr. 28, 2016, now Pat. No. 10,860,962.
Application No. 15/141,752 is a continuation-in-part of application No. 15/091,563, filed on Apr. 5, 2016, now Pat. No. 10,204,147.
Application No. 15/091,563 is a continuation-in-part of application No. 14/986,536, filed on Dec. 31, 2015, now Pat. No. 10,210,255.
Application No. 14/986,536 is a continuation-in-part of application No. 14/925,974, filed on Oct. 28, 2015, now abandoned.
Application No. 15/931,534 is a continuation-in-part of application No. 15/683,765, filed on Aug. 22, 2017, now abandoned.
Application No. 15/683,765 is a continuation-in-part of application No. 15/409,510, filed on Jan. 18, 2017, now abandoned.
Application No. 15/409,510 is a continuation-in-part of application No. 15/379,899, filed on Dec. 15, 2016, now abandoned.
Application No. 15/379,899 is a continuation-in-part of application No. 15/376,657, filed on Dec. 13, 2016, now Pat. No. 10,402,906.
Application No. 15/376,657 is a continuation-in-part of application No. 15/237,625, filed on Aug. 15, 2016, now Pat. No. 10,248,910.
Application No. 15/931,534 is a continuation-in-part of application No. 16/718,906, filed on Dec. 18, 2019, now Pat. No. 11,055,140.
Application No. 16/718,906 is a continuation of application No. 15/879,182, filed on Jan. 24, 2018, now Pat. No. 10,514,954.
Application No. 15/879,182 is a continuation-in-part of application No. 15/850,037, filed on Dec. 21, 2017, now abandoned.
Application No. 15/850,037 is a continuation-in-part of application No. 15/673,368, filed on Aug. 9, 2017, now abandoned.
Application No. 15/673,368 is a continuation-in-part of application No. 15/376,657, filed on Dec. 13, 2016, now Pat. No. 10,402,906.
Application No. 15/850,037 is a continuation-in-part of application No. 15/489,716, filed on Apr. 17, 2017, now abandoned.
Application No. 15/489,716 is a continuation-in-part of application No. 15/409,510, filed on Jan. 18, 2017, now abandoned.
Application No. 15/931,534 is a continuation-in-part of application No. 15/905,041, filed on Feb. 26, 2018, now Pat. No. 10,706,063.
Application No. 15/905,041 is a continuation-in-part of application No. 15/237,625, filed on Aug. 15, 2016, now Pat. No. 10,248,910.
Application No. 15/931,534 is a continuation-in-part of application No. 16/191,054, filed on Nov. 14, 2018, now Pat. No. 10,681,074.
Application No. 16/191,054 is a continuation-in-part of application No. 15/655,113, filed on Jul. 20, 2017, now Pat. No. 10,735,456.
Application No. 15/931,534 is a continuation-in-part of application No. 16/654,309, filed on Oct. 16, 2019, now abandoned.
Application No. 16/654,309 is a continuation-in-part of application No. 15/847,443, filed on Dec. 19, 2017, now abandoned.
Application No. 15/847,443 is a continuation-in-part of application No. 15/790,457, filed on Oct. 23, 2017, now Pat. No. 10,884,999.
Application No. 15/790,457 is a continuation-in-part of application No. 62/568,298, filed on Oct. 4, 2017.
Application No. 62/568,298 is a continuation-in-part of application No. 15/790,327, filed on Oct. 23, 2017, now Pat. No. 10,860,951.
Application No. 15/790,327 is a continuation-in-part of application No. 15/616,427, filed on Jun. 7, 2017, now abandoned.
Application No. 15/616,427 is a continuation-in-part of application No. 15/141,752, filed on Apr. 28, 2016, now Pat. No. 10,860,962.
Application No. 15/847,443 is a continuation-in-part of application No. 15/489,716, filed on Apr. 17, 2017, now abandoned.
Application No. 15/489,716 is a continuation-in-part of application No. 15/616,427, filed on Jun. 7, 2017, now abandoned.
Application No. 15/931,534 is a continuation-in-part of application No. 16/660,727, filed on Oct. 22, 2019, now Pat. No. 10,938,683.
Application No. 16/660,727 is a continuation of application No. 15/229,476, filed on Aug. 5, 2016, now Pat. No. 10,454,791.
Application No. 15/229,476 is a continuation-in-part of application No. 15/206,195, filed on Jul. 8, 2016, now abandoned.
Application No. 17/001,459 is a continuation-in-part of application No. 16/945,698, filed on Jul. 31, 2020, now abandoned.
Application No. 16/945,698 is a continuation-in-part of application No. 15/931,534, filed on May 13, 2020, now abandoned.
Application No. 15/931,534 is a continuation-in-part of application No. 16/864,133, filed on Apr. 30, 2020, now Pat. No. 11,494,665.
Application No. 16/864,133 is a continuation-in-part of application No. 15/847,443, filed on Dec. 19, 2017, now abandoned.
Application No. 16/945,698 is a continuation-in-part of application No. 16/915,176, filed on Jun. 29, 2020, now abandoned.
Application No. 16/915,176 is a continuation-in-part of application No. 15/847,443, filed on Dec. 19, 2017, now abandoned.
Application No. 15/847,443 is a continuation-in-part of application No. 15/891,329, filed on Feb. 7, 2018, now abandoned.
Application No. 15/891,329 is a continuation-in-part of application No. 15/860,980, filed on Jan. 3, 2018, now abandoned.
Application No. 15/860,980 is a continuation-in-part of application No. 15/850,037, filed on Dec. 21, 2017, now abandoned.
Application No. 15/850,037 is a continuation-in-part of application No. 15/788,002, filed on Oct. 19, 2017, now abandoned.
Application No. 15/788,002 is a continuation-in-part of application No. 15/787,601, filed on Oct. 18, 2017, now Pat. No. 10,860,660.
Application No. 15/787,601 is a continuation-in-part of application No. 15/616,427, filed on Jun. 7, 2017, now abandoned.
Application No. 16/915,176 is a continuation-in-part of application No. 15/905,041, filed on Feb. 26, 2018, now Pat. No. 10,706,063.
(60) Provisional application No. 62/568,291, filed on Oct. 4, 2017.
(60) Provisional application No. 62/568,305, filed on Oct. 4, 2017.

(51) Int. Cl. H04L 9/40; G06F 16/2458; G06F 16/951

(52) U.S. Cl. CPC H04L 63/20; G06F 16/2477; G06F 16/951; H04L 63/1425; H04L 63/1441

(57) ABSTRACT

A system and method for creation, augmentation, and expansion of high-quality data set collections for training of machine learning algorithms via crowdsourced curation that utilizes a data marketplace which incentivizes data gatherers, publishers, and users to contribute to the creation of a vast resource of reliable data set and knowledge collections and classifications. Data is automatically ingested from disparate sources and autonomously checked for data quality, provenance, uncertainty, and risks and subsequently given a score for a given use context. Data stewards curate a queue of low scoring real data as well as synthetically generated data for specific applications. All reputable data is stored for user (machine or human) consumption and further iterative data or model generation or utilization with appropriate provenance, curation, and license/use limitations and terms.

### CROSS-REFERENCE TO RELATED APPLICATIONS

Priority is claimed in the application data sheet to the following patents or patent applications, each of which is expressly incorporated herein by reference in its entirety:
Ser. No. 17/001,459
Ser. No. 16/983,233
Ser. No. 15/931,534
Ser. No. 16/777,270
Ser. No. 16/720,383
Ser. No. 15/823,363
Ser. No. 15/725,274
Ser. No. 15/655,113
Ser. No. 15/616,427
Ser. No. 14/925,974
Ser. No. 15/237,625
Ser. No. 15/206,195
Ser. No. 15/186,453
Ser. No. 15/166,158
Ser. No. 15/141,752
Ser. No. 15/091,563
Ser. No. 14/986,536
Ser. No. 16/718,906
Ser. No. 15/879,182
Ser. No. 15/850,037
Ser. No. 15/673,368
Ser. No. 15/376,657
Ser. No. 15/489,716
Ser. No. 15/409,510
Ser. No. 15/379,899
Ser. No. 16/660,727
Ser. No. 15/229,476
Ser. No. 16/654,309
Ser. No. 15/847,443
Ser. No. 15/790,457
Ser. No. 15/790,327
62/568,291
62/568,298
Ser. No. 16/191,054
Ser. No. 15/905,041
Ser. No. 15/683,765
Ser. No. 16/945,698
Ser. No. 16/915,176
Ser. No. 15/891,329
Ser. No. 15/860,980
Ser. No. 15/788,002
Ser. No. 15/787,601
62/568,312
62/568,305
Ser. No. 16/864,133

### BACKGROUND OF THE INVENTION

Field of the Art

This disclosure relates to the field of computer systems, and more particularly to the field of data set creation for training of machine learning algorithms.

### Discussion of the State of the Art

Modern day machine learning models require extensive data set collections in order to predict real-world phenomena, approximately ten times as many examples as there are degrees of freedom in the model. However, there is currently a lack of sufficient high quality data sets for training machine learning algorithms in many fields. Data sets often do not exist for a given field or purpose. Where data sets do exist, they are often insufficient in size and quality. Such data sets are often manually created, containing insufficient examples for reliable and accurate training of machine learning algorithms. Further, poorly curated data set collections are the norm, suffering from extensive quality issues and sometimes restricted by legislative and regulatory policies. Generation of synthetic data helps to solve the problem of supply, but worsens the quality of the training data. Synthetic data is prone to over-fitting and suffers from inherited quality problems from the training data used to generate the synthetic data and introduces artificial biases.

What is needed is a system and method for creation of high-quality data sets in sufficient quantity for reliable and accurate training of machine learning algorithms.

### SUMMARY OF THE INVENTION

Accordingly, the inventor has developed and reduced to practice a system and method for creation and expansion of high quality data set collections for training of machine learning algorithms via crowdsourced curation. One embodiment utilizes a data marketplace which incentivizes data gatherers, publishers, and users to contribute to the creation of a vast resource of reliable data set collections. To accomplish this, data is automatically ingested from disparate sources and autonomously checked for data quality, provenance, and cyber-risks and subsequently given a reputation score. Data stewards curate a queue of low scoring real data as well as synthetically generated data. All reputable data is stored for user consumption and further iterative data generation.

According to a preferred embodiment, a computing system for creation and expansion of high quality data set collections for training of machine learning algorithms via crowdsourced curation employing a cyber decision platform, the computing system comprising: one or more hardware processors configured for: receiving a data set; scoring a data entry within the data set, wherein the score is calculated from a plurality of scoring metrics; summing all of the data entry scores within the data set combining to form an overall reputation score; flagging an erroneous data entry which may not be resolved through a machine learning algorithm; comparing the overall reputation score with a numerical threshold for reputability; sending the flagged erroneous data entry and the data sets not meeting the threshold for reputability to a verification queue subsystem; storing the data sets that meet the threshold for reputability to a data store as a reputable data set collection; receiving the flagged erroneous data entry and the data sets not meeting the threshold for reputability; assigning the data in the verification queue to a data steward for human curation; and sending the curated and resolved data back to the reputation scoring engine for an additional iteration.

According to an aspect of an embodiment, the system further comprises a synthetic data generator comprising a third plurality of programming instructions stored in the memory of, and operating on the processor of, the computing device, wherein the third plurality of programming instructions, when operating on the processor, cause the computing device to: use a generative adversarial network to: receive a reputable data set collection stored within the data store; generate a synthetic data set based off the reputable data set; send the synthetic data set to the reputation scoring engine, where the synthetic data set passes the threshold for reputability merges with the reputable data set collection.

According to an aspect of an embodiment, the plurality of scoring metrics is associated with at least data quality, data provenance, or uncertainty and risks.

According to an aspect of an embodiment, the numerical threshold for reputability is based at least in part on the veracity of the dataset.

According to another preferred embodiment, a computer-implemented method executed on a cyber decision platform for creation and expansion of high quality data set collections for training of machine learning algorithms via crowdsourced curation, the computer-implemented method comprising: receiving a data set; scoring a data entry within the data set, wherein the score is calculated from a plurality of scoring metrics; summing all of the data entry scores within the data set combining to form an overall reputation score; flagging an erroneous data entry which may not be resolved through the machine learning algorithm; comparing the overall reputation score with a numerical threshold for reputability; sending the flagged erroneous data entry and the data sets not meeting the threshold for reputability to a verification queue; storing the data sets that meet the threshold for reputability to a data store; assigning the data in the verification queue to a data steward for human curation; and sending the curated data back for an additional iteration of the above process.

According to another preferred embodiment, a system for creation and expansion of high quality data set collections for training of machine learning algorithms via crowdsourced curation employing a cyber decision platform, comprising one or more computers with executable instructions that, when executed, cause the system to: receive a data set; score a data entry within the data set, wherein the score is calculated from a plurality of scoring metrics; sum all of the data entry scores within the data set combining to form an overall reputation score; flag an erroneous data entry which may not be resolved through a machine learning algorithm; compare the overall reputation score with a numerical threshold for reputability; send the flagged erroneous data entry and the data sets not meeting the threshold for reputability to a verification queue subsystem; store the data sets that meet the threshold for reputability to a data store as a reputable data set collection; receive the flagged erroneous data entry and the data sets not meeting the threshold for reputability; assign the data in the verification queue to a data steward for human curation; and send the curated and resolved data back to the reputation scoring engine for an additional iteration.

According to another preferred embodiment, non-transitory, computer-readable storage media having computer-executable instruction embodied thereon that, when executed by one or more processors of a computing system employing a cyber decision platform for creation and expansion of high quality data set collections for training of machine learning algorithms via crowdsourced curation, cause the computing system to: receive a data set; score a data entry within the data set, wherein the score is calculated from a plurality of scoring metrics; sum all of the data entry scores within the data set combining to form an overall reputation score; flag an erroneous data entry which may not be resolved through a machine learning algorithm; compare the overall reputation score with a numerical threshold for reputability; send the flagged erroneous data entry and the data sets not meeting the threshold for reputability to a verification queue subsystem; store the data sets that meet the threshold for reputability to a data store as a reputable data set collection; receive the flagged erroneous data entry and the data sets not meeting the threshold for reputability; assign the data in the verification queue to a data steward for human curation; and send the curated and resolved data back to the reputation scoring engine for an additional iteration.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1 is a block diagram of an exemplary system architecture for an advanced cyber decision platform.

FIG. 2 is a block diagram of an advanced cyber decision platform in an exemplary configuration for use in investment vehicle management.

FIGS. 3A&3B are process diagrams showing further detail regarding the operation of the advanced cyber decision platform.

FIG. 4 is a diagram of an exemplary system architecture for data set curation and generation with crowd-based reinforcement.

FIG. 5 PRIOR ART is a diagram of an exemplary logical architecture of a generative adversarial network used as a synthetic data generator.

FIG. 6 is a flow diagram of a simplified dataset being processed by an exemplary embodiment of the system.

FIG. 7 is a block diagram illustrating an exemplary hardware architecture of a computing device.

FIG. 8 is a block diagram illustrating an exemplary logical architecture for a client device.

FIG. 9 is a block diagram illustrating an exemplary architectural arrangement of clients, servers, and external services.

FIG. 10 is another block diagram illustrating an exemplary hardware architecture of a computing device.

### DETAILED DESCRIPTION OF THE INVENTION

The inventor has conceived, and reduced to practice, a system and method for creation and expansion of high-quality data set collections for training of machine learning algorithms via crowdsourced curation. One embodiment according to the inventor employs a data marketplace which incentivizes data gatherers, publishers, and users to contribute to an expeditiously growing and vast resource of reliable data sets. To accomplish this, data is automatically ingested from disparate sources and autonomously checked for quality, provenance, and security and subsequently given a data reputation score. The score is compared against a numerical threshold and determines whether the data is sufficiently reputable and if so, stores the data in the marketplace. A queue holds data that falls below the reputation threshold where qualified individuals known as data stewards, receive compensation to manually curate the data. Once curated the now reputable data is stored for consumption in the marketplace.

Currently, public and commercial data sets for training of machine learning algorithms suffer from a slow growing ecosystem which, as a consequence, contributes to a shortage of available data needed to simulate machine learning models across multiple domains. Additionally, modern computer algorithms are not capable of integrating outliers and nuances when preparing real-world training data or performing quality control measures (e.g., completeness, uniqueness, timeliness, validity, accuracy, and consistency) on new or existing data. As a result, development of data set collections is a burdensome, and often manual task which consumes a considerable amount of fiscal and organizational resources. What current data set creation methodologies lack is a collaborative environment in which to harness the power of numbers for both quality control and expanding data set collections.

In addition to crowdsourcing real data, a synthetic data generator may be used to produce additional training data from these curated high-quality data sets. For example, in one embodiment, a generative adversarial network (GAN, a class of machine learning frameworks) may be used to generate synthetic data to supplement lacking real-world data set collections. Once synthetic data has been generated and is indistinguishable from real data by the GAN, it is sent to the marketplace queue where data stewards perform quality control measures and various other tasks that are difficult for the machine learning. This crowdsourcing cycle (obtain real data, generate synthetic data, curate the synthetic data) solves the issue of slow growing, deficient, and unreliable data sets.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

A “database” or “data storage subsystem” (these terms may be considered substantially synonymous), as used herein, is a system adapted for the long-term storage, indexing, and retrieval of data, the retrieval typically being via some sort of querying interface or language. “Database” may be used to refer to relational database management systems known in the art, but should not be considered to be limited to such systems. Many alternative database or data storage system technologies have been, and indeed are being, introduced in the art, including but not limited to distributed non-relational data storage systems such as Hadoop, column-oriented databases, in-memory databases, and the like. While various aspects may preferentially employ one or another of the various data storage subsystems available in the art (or available in the future), the invention should not be construed to be so limited, as any data storage architecture may be used according to the aspects. Similarly, while in some cases one or more particular data storage needs are described as being satisfied by separate components (for example, an expanded private capital markets database and a configuration database), these descriptions refer to functional uses of data storage systems and do not refer to their physical architecture. For instance, any group of data storage systems of databases referred to herein may be included together in a single database management system operating on a single machine, or they may be included in a single database management system operating on a cluster of machines as is known in the art. Similarly, any single database (such as an expanded private capital markets database) may be implemented on a single machine, on a set of machines using clustering technology, on several machines connected by one or more messaging systems known in the art, or in a master/slave arrangement common in the art. These examples should make clear that no particular architectural approaches to database management is preferred according to the invention, and choice of data storage technology is at the discretion of each implementer, without departing from the scope of the invention as claimed.

A “data context,” as used herein, refers to a set of arguments identifying the location of data. This could be a Rabbit queue, a .csv file in cloud-based storage, or any other such location reference except a single event or record. Activities may pass either events or data contexts to each other for processing. The nature of a pipeline allows for direct information passing between activities, and data locations or files do not need to be predetermined at pipeline start.

As used herein, “graph” is a representation of information and relationships, where each primary unit of information makes up a “node” or “vertex” of the graph and the relationship between two nodes makes up an edge of the graph. Nodes can be further qualified by the connection of one or more descriptors or “properties” to that node. For example, given the node “James R,” name information for a person, qualifying properties might be “183 cm tall,” “DOB Aug. 13, 1965” and “speaks English”. Similar to the use of properties to further describe the information in a node, a relationship between two nodes that forms an edge can be qualified using a “label”. Thus, given a second node “Thomas G,” an edge between “James R” and “Thomas G” that indicates that the two people know each other might be labeled “knows.” When graph theory notation (Graph=(Vertices, Edges)) is applied this situation, the set of nodes are used as one parameter of the ordered pair, V and the set of 2 element edge endpoints are used as the second parameter of the ordered pair, E. When the order of the edge endpoints within the pairs of E is not significant, for example, the edge James R, Thomas G is equivalent to Thomas G, James R, the graph is designated as “undirected.”

Under circumstances when a relationship flows from one node to another in one direction, for example James R is “taller” than Thomas G, the order of the endpoints is significant. Graphs with such edges are designated as “directed.” In the distributed computational graph system, transformations within transformation pipeline are represented as directed graph with each transformation comprising a node and the output messages between transformations comprising edges. Distributed computational graph stipulates the potential use of non-linear transformation pipelines which are programmatically linearized. Such linearization can result in exponential growth of resource consumption. The most sensible approach to overcome possibility is to introduce new transformation pipelines just as they are needed, creating only those that are ready to compute. Such method results in transformation graphs which are highly variable in size and node, edge composition as the system processes data streams. Those familiar with the art will realize that transformation graph may assume many shapes and sizes with a vast topography of edge relationships. The examples given were chosen for illustrative purposes only and represent a small number of the simplest of possibilities. These examples should not be taken to define the possible graphs expected as part of operation of the invention.

A “pipeline,” as used herein and interchangeably referred to as a “data pipeline” or a “processing pipeline,” refers to a set of data streaming activities and batch activities. Streaming and batch activities can be connected indiscriminately within a pipeline. Events will flow through the streaming activity actors in a reactive way. At the junction of a streaming activity to batch activity, there will exist a StreamBatchProtocol data object. This object is responsible for determining when and if the batch process is run. One or more of three possibilities can be used for processing triggers: regular timing interval, every N events, or optionally an external trigger. The events are held in a queue or similar until processing. Each batch activity may contain a “source” data context (this may be a streaming context if the upstream activities are streaming), and a “destination” data context (which is passed to the next activity). Streaming activities may have an optional “destination” streaming data context (optional meaning: caching/persistence of events vs. ephemeral), though this should not be part of the initial implementation.

As used herein, “transformation” is a function performed on zero or more streams of input data which results in a single stream of output which may or may not then be used as input for another transformation. Transformations may comprise any combination of machine, human or machine-human interactions Transformations need not change data that enters them, one example of this type of transformation would be a storage transformation which would receive input and then act as a queue for that data for subsequent transformations. As implied above, a specific transformation may generate output data in the absence of input data. A time stamp serves as an example. In the invention, transformations are placed into pipelines such that the output of one transformation may serve as an input for another. These pipelines can consist of two or more transformations with the number of transformations limited only by the resources of the system. Historically, transformation pipelines have been linear with each transformation in the pipeline receiving input from one antecedent and providing output to one subsequent with no branching or iteration. Other pipeline configurations are possible. The invention is designed to permit several of these configurations including, but not limited to: linear, afferent branch, efferent branch and cyclical.

### Conceptual Architecture

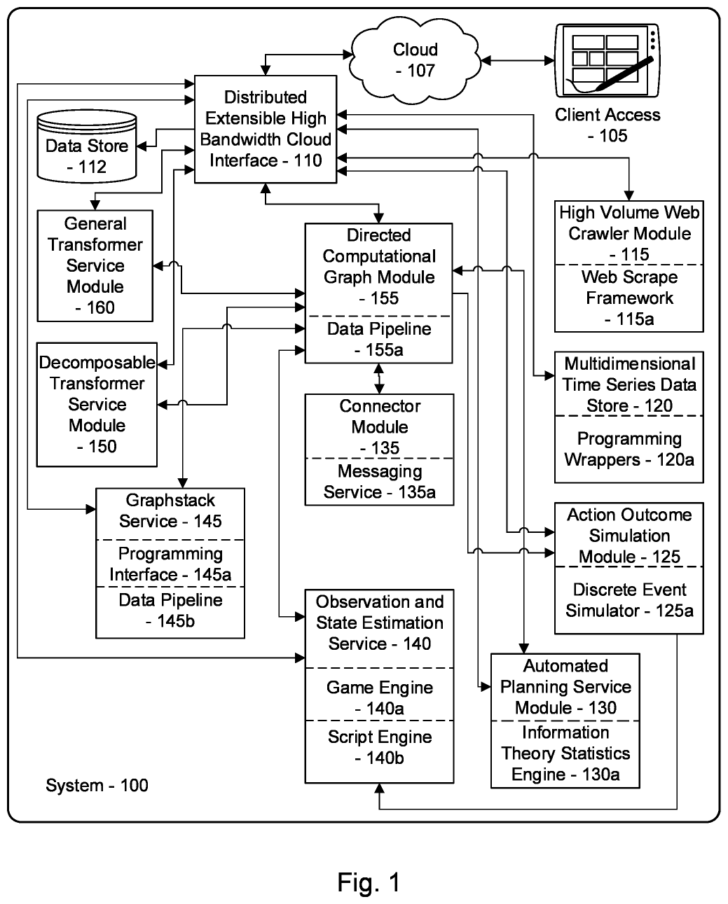

FIG. 1 is a block diagram of an advanced cyber decision platform. Client access to the system 105 for specific data entry, system control and for interaction with system output such as automated predictive decision making and planning and alternate pathway simulations, occurs through the system's distributed, extensible high bandwidth cloud interface 110 which uses a versatile, robust web application driven interface for both input and display of client-facing information via network 107 and operates a data store 112 such as, but not limited to MONGODB™, COUCHDB™, CASSANDRA™ or REDIS™ according to various arrangements. Much of the business data analyzed by the system both from sources within the confines of the client business, and from cloud based sources, also enter the system through the cloud interface 110, data being passed to the connector module 135 which may possess the API routines 135a needed to accept and convert the external data and then pass the normalized information to other analysis and transformation components of the system, the directed computational graph module 155, high volume web crawler module 115, multidimensional time series database (MDTSDB) 120 and the graph stack service 145. The directed computational graph module 155 retrieves one or more streams of data from a plurality of sources, which includes, but is in no way not limited to, a plurality of physical sensors, network service providers, web based questionnaires and surveys, monitoring of electronic infrastructure, crowd sourcing campaigns, and human input device information. Within the directed computational graph module 155, data may be split into two identical streams in a specialized pre-programmed data pipeline 155a, wherein one sub-stream may be sent for batch processing and storage while the other sub-stream may be reformatted for transformation pipeline analysis. The data is then transferred to the general transformer service module 160 for linear data transformation as part of analysis or the decomposable transformer service module 150 for branching or iterative transformations that are part of analysis. The directed computational graph module 155 represents all data as directed graphs where the transformations are nodes and the result messages between transformations edges of the graph. The high volume web crawling module 115 uses multiple server hosted preprogrammed web spiders, which while autonomously configured are deployed within a web scraping framework 115a of which SCRAPY™ is an example, to identify and retrieve data of interest from web based sources that are not well tagged by conventional web crawling technology. The multiple dimension time series data store module 120 may receive streaming data from a large plurality of sensors that may be of several different types. The multiple dimension time series data store module may also store any time series data encountered by the system such as but not limited to enterprise network usage data, component and system logs, performance data, network service information captures such as, but not limited to news and financial feeds, and sales and service related customer data. The module is designed to accommodate irregular and high volume surges by dynamically allotting network bandwidth and server processing channels to process the incoming data. Inclusion of programming wrappers 120a for languages examples of which are, but not limited to C++, PERL, PYTHON, and ERLANG™ allows sophisticated programming logic to be added to the default function of the multidimensional time series database 120 without intimate knowledge of the core programming, greatly extending breadth of function. Data retrieved by the multidimensional time series database (MDTSDB) 120 and the high volume web crawling module 115 may be further analyzed and transformed into task optimized results by the directed computational graph 155 and associated general transformer service 150 and decomposable transformer service 160 modules. Alternately, data from the multidimensional time series database and high volume web crawling modules may be sent, often with scripted cuing information determining important vertexes 145a, to the graph stack service module 145 which, employing standardized protocols for converting streams of information into graph representations of that data, for example, open graph internet technology although the invention is not reliant on any one standard. Through the steps, the graph stack service module 145 represents data in graphical form influenced by any pre-determined scripted modifications 145a and stores it in a graph-based data store 145b such as GIRAPH™ or a key value pair type data store REDIS™, or RIAK™, among others, all of which are suitable for storing graph-based information.

Results of the transformative analysis process may then be combined with further client directives, additional business rules and practices relevant to the analysis and situational information external to the already available data in the automated planning service module 130 which also runs powerful information theory 130a based predictive statistics functions and machine learning algorithms to allow future trends and outcomes to be rapidly forecast based upon the current system derived results and choosing each a plurality of possible business decisions. The using all available data, the automated planning service module 130 may propose business decisions most likely to result is the most favorable business outcome with a usably high level of certainty. Closely related to the automated planning service module in the use of system derived results in conjunction with possible externally supplied additional information in the assistance of end user business decision making, the action outcome simulation module 125 with its discrete event simulator programming module 125a coupled with the end user facing observation and state estimation service 140 which is highly scriptable 140b as circumstances require and has a game engine 140a to more realistically stage possible outcomes of business decisions under consideration, allows business decision makers to investigate the probable outcomes of choosing one pending course of action over another based upon analysis of the current available data.

When performing external reconnaissance via a network 107, web crawler 115 may be used to perform a variety of port and service scanning operations on a plurality of hosts. This may be used to target individual network hosts (for example, to examine a specific server or client device) or to broadly scan any number of hosts (such as all hosts within a particular domain, or any number of hosts up to the complete IPv4 address space). Port scanning is primarily used for gathering information about hosts and services connected to a network, using probe messages sent to hosts that prompt a response from that host. Port scanning is generally centered around the transmission control protocol (TCP), and using the information provided in a prompted response a port scan can provide information about network and application layers on the targeted host.

Port scan results can yield information on open, closed, or undetermined ports on a target host. An open port indicated that an application or service is accepting connections on this port (such as ports used for receiving customer web traffic on a web server), and these ports generally disclose the greatest quantity of useful information about the host. A closed port indicates that no application or service is listening for connections on that port, and still provides information about the host such as revealing the operating system of the host, which may be discovered by fingerprinting the TCP/IP stack in a response. Different operating systems exhibit identifiable behaviors when populating TCP fields, and collecting multiple responses and matching the fields against a database of known fingerprints makes it possible to determine the OS of the host even when no ports are open. An undetermined port is one that does not produce a requested response, generally because the port is being filtered by a firewall on the host or between the host and the network (for example, a corporate firewall behind which all internal servers operate).

Scanning may be defined by scope to limit the scan according to two dimensions, hosts and ports. A horizontal scan checks the same port on multiple hosts, often used by attackers to check for an open port on any available hosts to select a target for an attack that exploits a vulnerability using that port. This type of scan is also useful for security audits, to ensure that vulnerabilities are not exposed on any of the target hosts. A vertical scan defines multiple ports to examine on a single host, for example a “vanilla scan” which targets every port of a single host, or a “strobe scan” that targets a small subset of ports on the host. This type of scan is usually performed for vulnerability detection on single systems, and due to the single-host nature is impractical for large network scans. A block scan combines elements of both horizontal and vertical scanning, to scan multiple ports on multiple hosts. This type of scan is useful for a variety of service discovery and data collection tasks, as it allows a broad scan of many hosts (up to the entire Internet, using the complete IPv4 address space) for a number of desired ports in a single sweep.

Large port scans involve quantitative research, and as such may be treated as experimental scientific measurement and are subject to measurement and quality standards to ensure the usefulness of results. To avoid observational errors during measurement, results must be precise (describing a degree of relative proximity between individual measured values), accurate (describing relative proximity of measured values to a reference value), preserve any metadata that accompanies the measured data, avoid misinterpretation of data due to faulty measurement execution, and must be well-calibrated to efficiently expose and address issues of inaccuracy or misinterpretation. In addition to these basic requirements, large volumes of data may lead to unexpected behavior of analysis tools, and extracting a subset to perform initial analysis may help to provide an initial overview before working with the complete data set. Analysis should also be reproducible, as with all experimental science, and should incorporate publicly-available data to add value to the comprehensibility of the research as well as contributing to a “common framework” that may be used to confirm results.

When performing a port scan, web crawler 115 may employ a variety of software suitable for the task, such as Nmap, ZMap, or masscan. Nmap is suitable for large scans as well as scanning individual hosts, and excels in offering a variety of diverse scanning techniques. ZMap is a newer application and unlike Nmap (which is more general-purpose), ZMap is designed specifically with

Internet-wide scans as the intent. As a result, ZMap is far less customizable and relies on horizontal port scans for functionality, achieving fast scan times using techniques of probe randomization (randomizing the order in which probes are sent to hosts, minimizing network saturation) and asynchronous design (utilizing stateless operation to send and receive packets in separate processing threads). Masscan uses the same asynchronous operation model of ZMap, as well as probe randomization. In masscan however, a certain degree of statistical randomness is sacrificed to improve computation time for large scans (such as when scanning the entire IPv4 address space), using the BlackRock algorithm. This is a modified implementation of symmetric encryption algorithm DES, with fewer rounds and modulo operations in place of binary ones to allow for arbitrary ranges and achieve faster computation time for large data sets.

Received scan responses may be collected and processed through a plurality of data pipelines 155a to analyze the collected information. MDTSDB 120 and graph stack 145 may be used to produce a hybrid graph/time-series database using the analyzed data, forming a graph of Internet-accessible organization resources and their evolving state information over time. Customer-specific profiling and scanning information may be linked to CPG graphs for a particular customer, but this information may be further linked to the base-level graph of internet-accessible resources and information. Depending on customer authorizations and legal or regulatory restrictions and authorizations, techniques used may involve both passive, semi-passive and active scanning and reconnaissance.

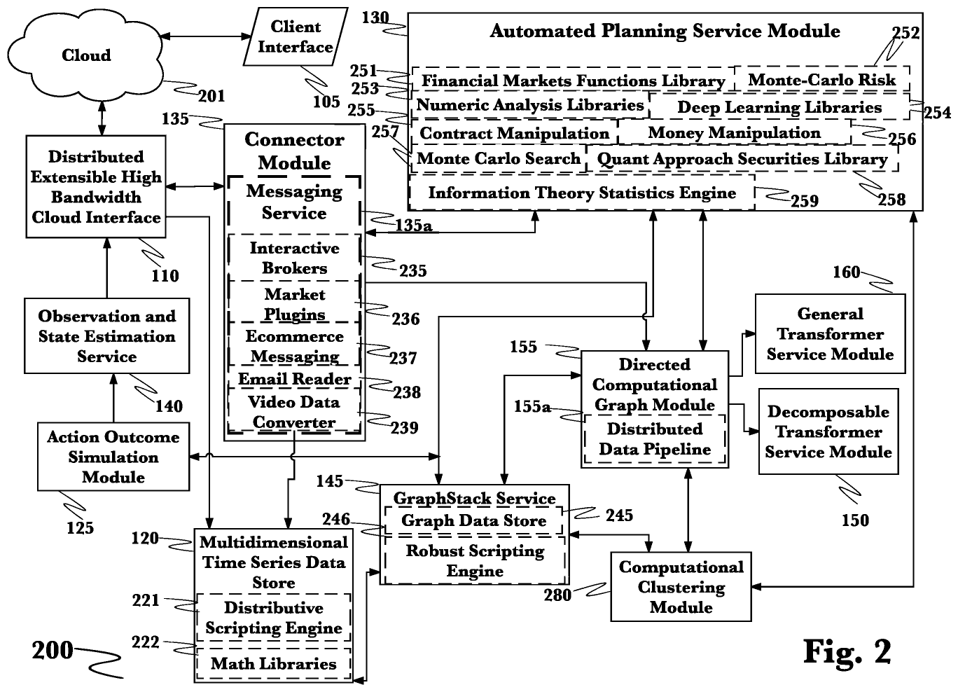

FIG. 2 is a block diagram of an advanced cyber decision platform in an exemplary configuration for use in investment vehicle management 200. The advanced cyber decision platform 100 previously disclosed in co-pending application Ser. No. 15/141,752 and applied in a role of cybersecurity in co-pending application Ser. No. 15/237,625, when programmed to operate as quantitative trading decision platform, is very well suited to perform advanced predictive analytics and predictive simulations 202 to produce investment predictions. Much of the trading specific programming functions are added to the automated planning service module 130 of the modified advanced cyber decision platform 100 to specialize it to perform trading analytics. Specialized purpose libraries may include but are not limited to financial markets functions libraries 251, Monte-Carlo risk routines 252, numeric analysis libraries 253, deep learning libraries 254, contract manipulation functions 255, money handling functions 256, Monte-Carlo search libraries 257, and quant approach securities routines 258. Pre-existing deep learning routines including information theory statistics engine 259 may also be used. The invention may also make use of other libraries and capabilities that are known to those skilled in the art as instrumental in the regulated trade of items of worth. Data from a plurality of sources used in trade analysis are retrieved, much of it from remote, cloud resident 201 servers through the system's distributed, extensible high bandwidth cloud interface 110 using the system's connector module 135 which is specifically designed to accept data from a number of information services both public and private through interfaces to those service's applications using its messaging service 135a routines, due to ease of programming, are augmented with interactive broker functions 235, market data source plugins 236, e-commerce messaging interpreters 237, business-practice aware email reader 238 and programming libraries to extract information from video data sources 239.

Other modules that make up the advanced cyber decision platform may also perform significant analytical transformations on trade related data. These may include the multidimensional time series data store 120 with its robust scripting features which may include a distributive friendly, fault-tolerant, real-time, continuous run prioritizing, programming platform such as, but not limited to Erlang/OTP 221 and a compatible but comprehensive and proven library of math functions of which the C⁺⁺ math libraries are an example 222, data formalization and ability to capture time series data including irregularly transmitted, burst data; the GraphStack service 145 which transforms data into graphical representations for relational analysis and may use packages for graph format data storage such as Titan 245 or the like and a highly interface accessible programming interface an example of which may be Akka/Spray, although other, similar, combinations may equally serve the same purpose in this role 246 to facilitate optimal data handling; the directed computational graph module 155 and its distributed data pipeline 155a supplying related general transformer service module 160 and decomposable transformer module 150 which may efficiently carry out linear, branched, and recursive transformation pipelines during trading data analysis may be programmed with multiple trade related functions involved in predictive analytics of the received trade data. Both possibly during and following predictive analyses carried out by the system, results must be presented to clients 105 in formats best suited to convey the both important results for analysts to make highly informed decisions and, when needed, interim or final data in summary and potentially raw for direct human analysis. Simulations which may use data from a plurality of field spanning sources to predict future trade conditions these are accomplished within the action outcome simulation module 125. Data and simulation formatting may be completed or performed by the observation and state estimation service 140 using its ease of scripting and gaming engine to produce optimal presentation results.

In cases where there are both large amounts of data to be cleansed and formalized and then intricate transformations such as those that may be associated with deep machine learning, first disclosed in ¶[067] of co-pending application Ser. No. 14/925,974, predictive analytics and predictive simulations, distribution of computer resources to a plurality of systems may be routinely required to accomplish these tasks due to the volume of data being handled and acted upon. The advanced cyber decision platform employs a distributed architecture that is highly extensible to meet these needs. A number of the tasks carried out by the system are extremely processor intensive and for these, the highly integrated process of hardware clustering of systems, possibly of a specific hardware architecture particularly suited to the calculations inherent in the task, is desirable, if not required for timely completion. The system includes a computational clustering module 280 to allow the configuration and management of such clusters during application of the advanced cyber decision platform. While the computational clustering module is drawn directly connected to specific co-modules of the advanced cyber decision platform these connections, while logical, are for ease of illustration and those skilled in the art will realize that the functions attributed to specific modules of an embodiment may require clustered computing under one use case and not under others. Similarly, the functions designated to a clustered configuration may be role, if not run, dictated. Further, not all use cases or data runs may use clustering.

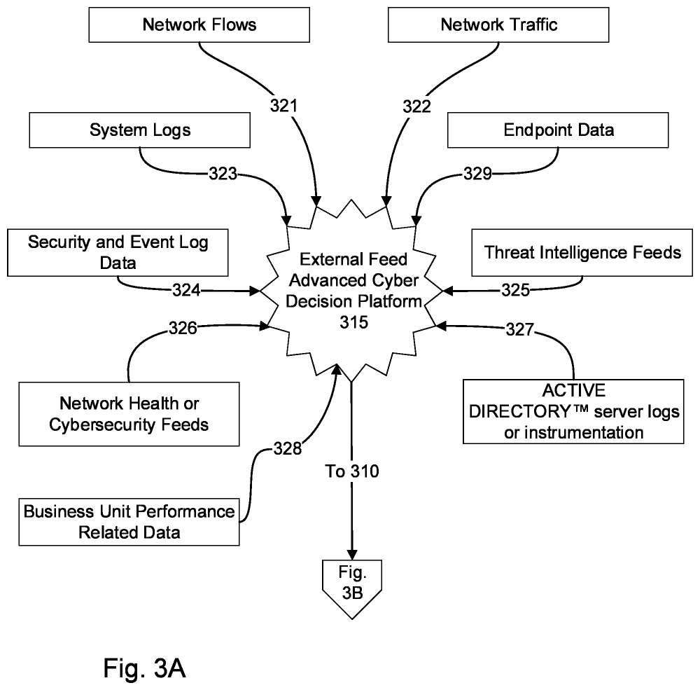

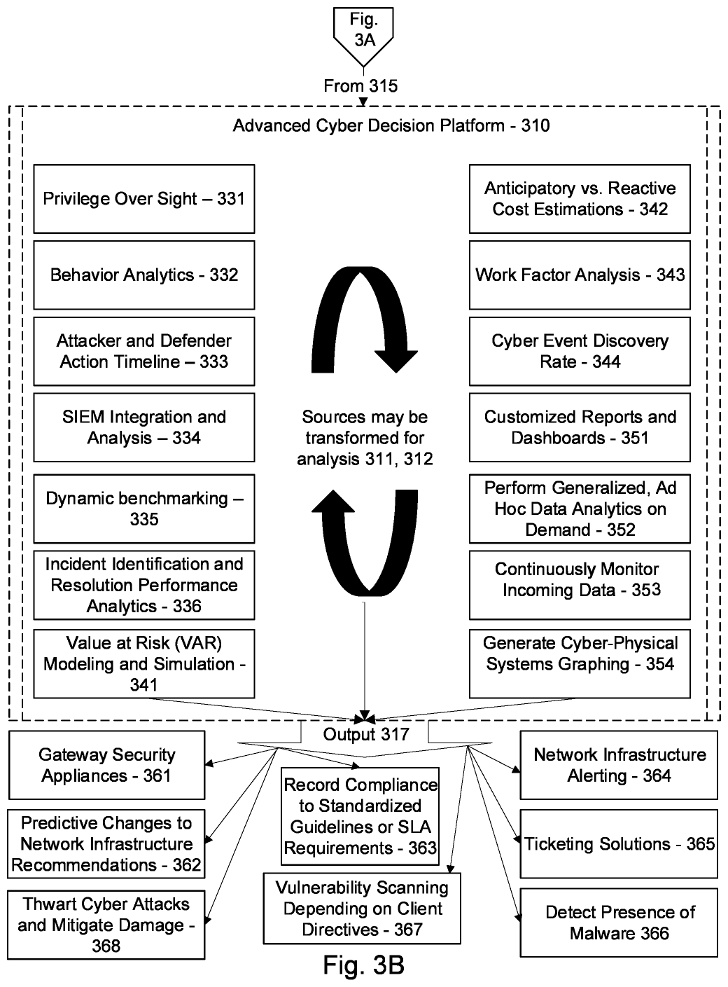

FIGS. 3A and 3B are process diagrams showing further detail regarding the operation of the advanced cyber decision platform. Input network data which may include network flow patterns 321, the origin and destination of each piece of measurable network traffic 322, system logs from servers and workstations on the network 323, endpoint data 329, any security event log data from servers or available security information and event (SIEM) systems 324, external threat intelligence feeds 324, identity or assessment context 325, external network health or cybersecurity feeds 326, Kerberos domain controller or ACTIVE DIRECTORY™ server logs or instrumentation 327, business unit performance related data 328, endpoint data 329, among many other possible data types for which the invention was designed to analyze and integrate, may pass into 315 the advanced cyber decision platform 310 for analysis as part of its cyber security function. These multiple types of data from a plurality of sources may be transformed for analysis 311, 312 using at least one of the specialized cybersecurity, risk assessment or common functions of the advanced cyber decision platform in the role of cybersecurity system, such as, but not limited to network and system user privilege oversight 331, network and system user behavior analytics 332, attacker and defender action timeline 333, SIEM integration and analysis 334, dynamic benchmarking 335, and incident identification and resolution performance analytics 336 among other possible cybersecurity functions; value at risk (VAR) modeling and simulation 341, anticipatory vs. reactive cost estimations of different types of data breaches to establish priorities 342, work factor analysis 343 and cyber event discovery rate 344 as part of the system's risk analytics capabilities; and the ability to format and deliver customized reports and dashboards 351, perform generalized, ad hoc data analytics on demand 352, continuously monitor, process and explore incoming data for subtle changes or diffuse informational threads 353 and generate cyber-physical systems graphing 354 as part of the advanced cyber decision platform's common capabilities. Output 317 can be used to configure network gateway security appliances 361, to assist in preventing network intrusion through predictive change to infrastructure recommendations 362, to alert an enterprise of ongoing cyberattack early in the attack cycle, possibly thwarting it but at least mitigating the damage 362, to record compliance to standardized guidelines or SLA requirements 363, to continuously probe existing network infrastructure and issue alerts to any changes which may make a breach more likely 364, suggest solutions to any domain controller ticketing weaknesses detected 365, detect presence of malware 366, perform one time or continuous vulnerability scanning depending on client directives 367, and thwart or mitigate damage from cyber-attacks 368. These examples are, of course, only a subset of the possible uses of the system, they are exemplary in nature and do not reflect any boundaries in the capabilities of the invention.

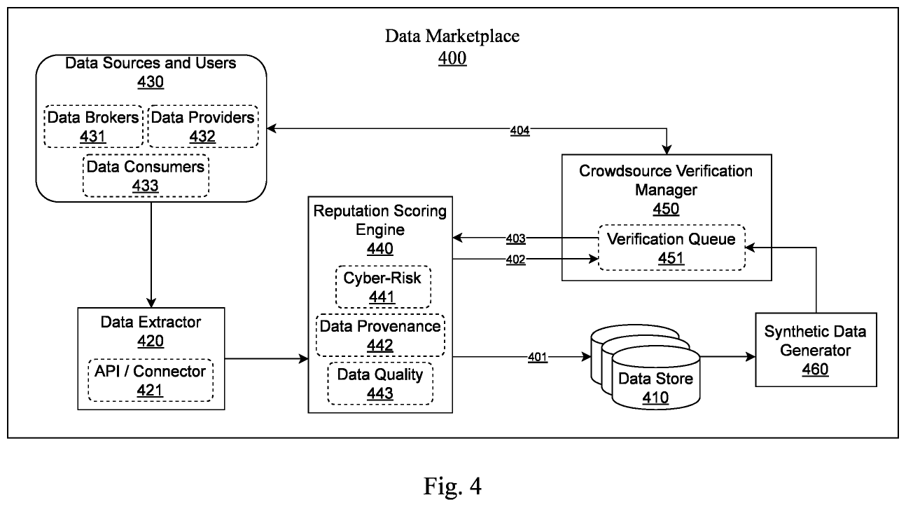

FIG. 4 is a diagram of an exemplary system architecture for data set curation and generation with crowd-based reinforcement. According to one embodiment, a data marketplace 400 is a growing data ecosystem that allows data brokers 431, providers 432, and consumers 433 the ability to contribute and curate data to create a mutually beneficial store 410 of reliable and large data set collections. The data marketplace 400 may utilize any number of marketing and business models to recruit, employ, and compensate businesses and individuals in this enterprise.

According to an aspect of this embodiment, a data extractor 420 comprises a series of ingestion APIs and connectors 421 that retrieve or receive commercial and public data sets from data brokers 431 and providers 432. Additional embodiments may include the ingestion of unstructured data and various other structured data sources. A reputation scoring engine 440 processes the ingested data 402 and assigns a reputation score. The reputation score is comprised of a cyber-risk score 441, data provenance score 442, and a data quality score 443.

The cyber-risk score is generated from information gathered about the source of the data. This may include the data broker's 431 or provider's 432 operations, including such information as business processes and policies, business process dependencies, prior data loss information and security breaches, and behavioral data for both devices and their users. The scoring may further comprise active and passive internal and external reconnaissance of the organization to determine cybersecurity vulnerabilities and potential impacts to the data set in light of the information gathered about the organization's infrastructure and operations. As an example, data breaches may imply compromised data sets and would lower the cyber-risk portion of the reputation score by a significant amount. Detailed information about reconnaissance for cybersecurity applications is contained in U.S. patent application Ser. No. 16/777,270, which is incorporated herein by reference.

The data provenance score 442 is based on the chain of custody or path data has taken. This includes consideration of the hardware and software that has processed the data where potential vulnerabilities associated with specific hardware and software may allow malicious actors to alter data. Also analyzed are the users which have accessed or modified the data. Whether or not the data has followed all imposed data restrictions such as the European Union's general data protection regulations or other legal or regulatory compliance mechanisms. Detailed information about a system and method for data provenance is contained in U.S. patent application Ser. No. 15/931,534, which is incorporated herein by reference.

The data quality score 443 quantifies the quality of the data for its intended purpose. In one embodiment, the data quality score 443 is based on six metrics. The first metric is the completeness of the data. The percentage of completeness reduces in the absence of critical data fields. The second metric is uniqueness. More distinct data leads to better results so the reputation scoring engine compares newly ingested data with itself and with data already stored within the marketplace. Uniqueness may be determined as one hundred percent if the number of new data items is unique and equal to the number of data items in the available data set. The third metric is timeliness. Certain applications require up to date information such as some financial, navigational, and cybersecurity models. Stock market data from the 1930's may not be as relevant today as from the earlier 2000's. Validity is the fourth metric and parallels the cyber-risk score 441 in that it examines the hardware and software that accesses the data. However, it determines the physical and logical integrity by analyzing event logs. Data that was recreated from a failed persistence layer (e.g., RAID) is an example of a physical integrity issue where incomplete or inconsistent logs may be one example of a logical integrity issue. Data accuracy is fifth in the overall data quality score 443. Data which accuracy represents the real-world context gains a higher score than poorly modeled references.

Typically, the more data fields the better, however, this is not always the case. Data sets about automobiles may have a significant quantity of data fields such as the number of gauges in the dash cluster or whether an automobile has an integrated compact disc player, but the majority of which may not be useful to most applications; however, sanitized medical records may share a similar amount of data fields containing symptoms but would prove useful in many machine learning models. Lastly, consistency measures the data against itself but from other sources with similar specifications.

Regarding the three main components of the reputation score, namely cyber-risk 441, data provenance 442, and data quality 443, machine learning algorithms may handle a majority of the assigned tasks. Any scoring metric that produces an error, outlier, or unknown result is earmarked 402 for the queue 451 in a crowdsource verification manager 450. Any ingested data that meets a specified threshold of reputability may be automatically merged and persisted 401 in the marketplace data store 410 without the need for human intervention. According to one embodiment, qualified users 430, known as data stewards from here out, may navigate to a web-interface or be notified by email or other communication of the opportunity 404 to curate data in the queue 451. Data stewards are then presented with the queued data along with the earmarked criteria. The data steward performs alterations or corrections on the data, provides direction or clarification for the reputation scoring engine 440, or marks the data as unsalvageable. Examples of actions a user might perform on data from the queue 451 comprises filling in missing data, resolving merge conflicts, converting data formats, updating old information, confirming large batch jobs, scheduled auditing, creating labels, and various other data cleansing and preprocessing functions. Once the proper actions have taken place on the data, it is sent back 403 to the reputation scoring engine 440 for another evaluation. This will iterate through the data until the threshold of reputability has been met and the data can be stored in a persistence layer 410. An additional aspect of the dynamics between the reputation scoring engine 440 and the crowdsource verification manager 450 is that corrections made by the data steward may be fed back into the machine learning model to improve the reputation scoring engine's 440 accuracy. Additional embodiments may comprise having established users verify actions performed in the queue by new users so as to mitigate inaccurate and costly errors.

Inadequate data set collections persisted in the data store 410 are identified either by continuously low reputation scores or a demand from data consumers 433 and initiate a synthetic data generator 460 to start a data generation job. Relevant data from the data store 410 is sent as training data to the synthetic data generator 460. The synthetic data generator generates synthetic data from the high quality curated data from the crowdsource verification manager 450 and reputation scoring engine 440. Data from the synthetic data generator 460 is fed into the verification queue 451. Data stewards verify the veracity of the synthetic data and upon completion the data goes into the reputation scoring engine 440. After a reputable score is met, the data is then merged with the stored data in the persistence layer 410.

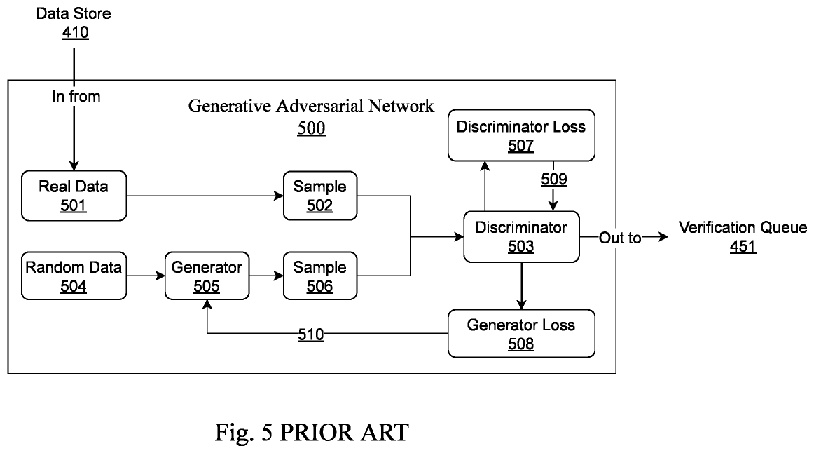

FIG. 5 PRIOR ART is a diagram of an exemplary logical architecture of a generative adversarial network 500 used as a synthetic data generator. The reputation scoring engine from FIG. 4 flags specific data set collections which need additional data for any reason. All relevant reputable data stored in the data store 410 gets sent as training data or otherwise known as real data 501 in the context of generative adversarial networks (GAN) to the generative adversarial network 500. The reputation scoring engine may also be configured to queue 451 the training data for review by a data steward before sending the data to the generative adversarial network 500.

A sample 502 of real data 501 is sent to the discriminator 503 and compared against a sample 506 of random data 504 output by the generator 505. The generative adversarial network 500 trains the generator 505 and discriminator 503 during alternate iterations via back propagation. Otherwise stated, the output values of each iteration (discriminator loss 507 or generator loss 508 during discriminator training and generator training, respectively) are calculated (and cached) in a forward pass. Then, the partial derivative of the error with respect to each parameter is calculated in a backward pass 509, 510 through the graph.

The generator 505 and discriminator 503 operate in a competitive relationship. The discriminator 503 learns to tell the difference between real 502 and synthetic data 506 while the generator 505 learns to create more convincing synthetic data 506. Once the generator can output samples 506 with a fifty percent succession rate (according to one embodiment), the discriminator 503 sends the sample 506 to the verification queue 451. At the queue 451, data stewards are compensated for verifying the accuracy or making corrections to the synthetic data with relation to the real data. This auditing of synthetic data solves the problem of overfitting and biases GANs are prone to.

An example of this system is generating stock market orders for financial research that requires huge volumes of data. Additionally, real-world data offers only one historical view and provides no lateral understanding of variances that could have happened in the market. Therefore, the synthetic data generator may be employed to generate synthetic stock market data and evaluate it against real-world stock market streams to produce valuable alternative data options for market researchers. The discriminator 503 would use a plurality of key determinates such as the distribution of price and quantity of orders, inter-arrival times of orders, and the highest bid and highest ask evolution over time to comparatively measure the synthetic data 506. Synthetic data 506 once found to be reputable by the data marketplace, would merge with stored real data increasing the overall volume of the financial data set collection.

### Detailed Description of Exemplary Aspects

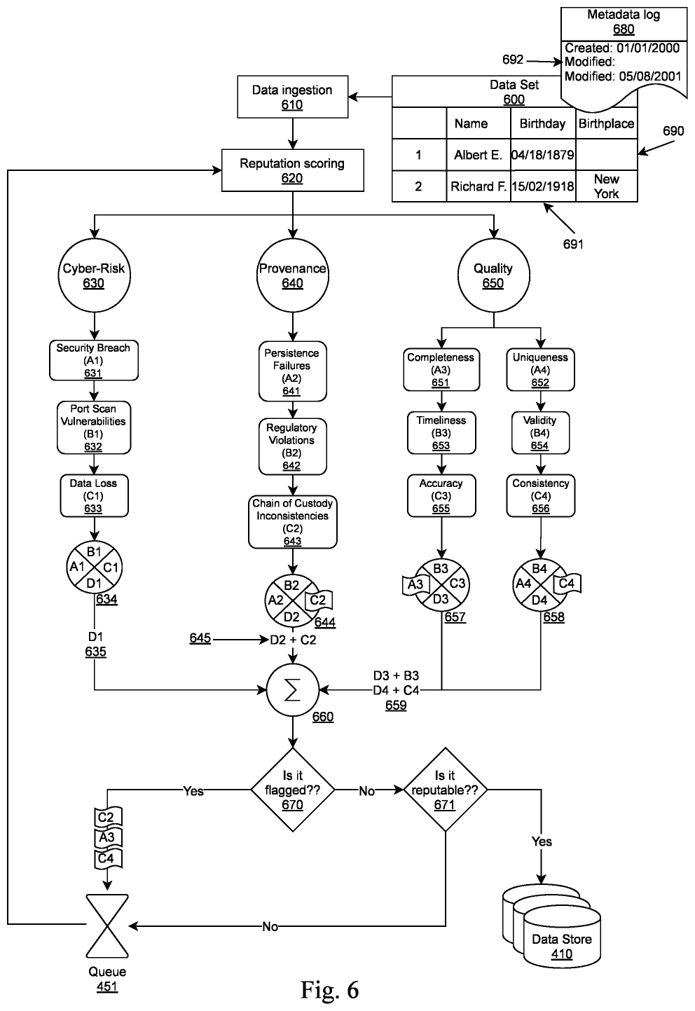

FIG. 6 is a flow diagram of a simplified dataset being processed by an exemplary embodiment of the system. According to this embodiment, a reputation scoring engine receives an ingested 610 data set 600 and begins the process of scoring 620 its reputability. Machine learning (ML) algorithms score each data set 600 entry by a plurality of metrics. These scores are represented symbolically in FIG. 6 as A1 631, B1 632, and C1 633 for cyber-risk metrics 630, A2 641, B2 642, and C2 643 for the provenance metrics 640, and A3 651, B3 653, C3 655, A4 652, B4 654, and C4 656 for the quality scoring metrics 650. All scores are summed in respective summing blocks 634,644, 657, 658 before being combined for a final score 660. After the final score is calculated 660, the reputation scoring engine sends 670 any flagged data fields and the relevant information to the verification queue 451. When no flags are identified, the overall score 660 is compared 671 against the minimum score required to be considered reputable. Data meeting the threshold goes on to be stored in a persistence layer (data store 410) where unflagged but still unreputable data is sent to the verification queue 451 for human analysis.

As a simplified example of this embodiment, consider the data set 600. The data set 600 has two errors 690,691 in the data itself, and one 692 in the metadata 680. In this example, the machine learning algorithms successfully scored security breaches (A1) 631, port scans (B1) 632, and data loss events (C1) 633 and subsequently totaled and sent the score (D1 635) to the summing block 660.

During the provenance 640 scoring routine, the ML algorithms discovered a missing entry 692 in the metadata log 680 and flagged it for the verification queue 451. When the scores are totaled, the reputation scoring engine will attach a flag to that particular erroneous entry 692 and pass that along 645 to the summing block 660.

Also, regarding this example, the data quality checks 650 revealed problematic entries in the data itself. Missing information such as Albert E.'s birthplace 690 cause completeness (A3) 651 to be earmarked for review and the consistency scoring metric (C4) 656 is flagged due to inconsistent date formats (day/month/year or month/day/year). Finally, the overall reputation score is totaled 660 from the independent metric scores; D1 635, D2 645, D3, and D4 659 and flagged entry information is sent to the queue 451.

After data stewards resolve issues 690, 961, and 692, the data set 600 is received once again for reputation scoring 620. Considering all erroneous information is resolved and the data set 600 meets the threshold for reputability 671, the data set 600 is then merged with the relevant data set collection within the data store 410 or creates a new collection should one not exist.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines, or other appropriate virtual environments).

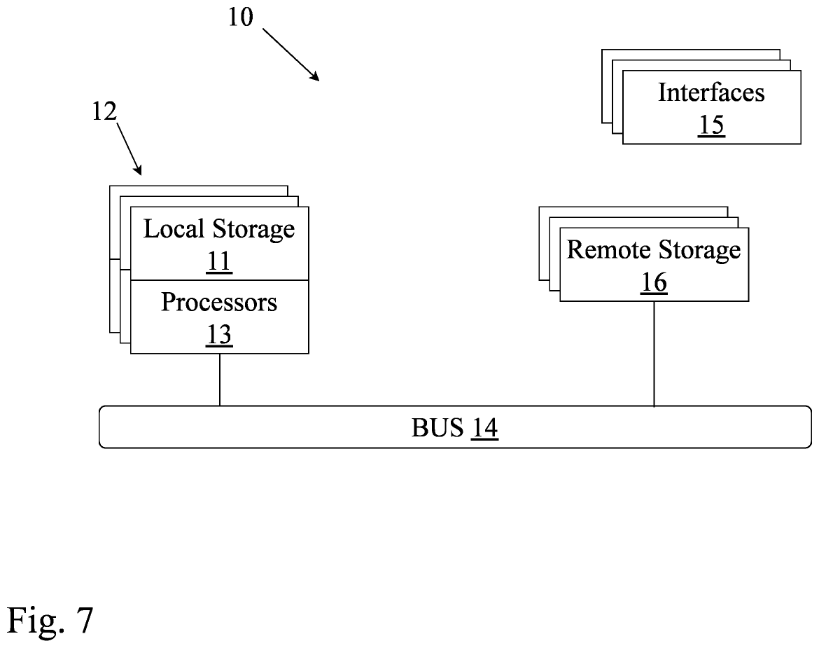

Referring now to FIG. 7, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some aspects, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 7 illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device aspects may include nontransitory machine-readable storage media, which, for example, may be configured or designed to store program instructions, state information, and the like for performing various operations described herein. Examples of such nontransitory machine- readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

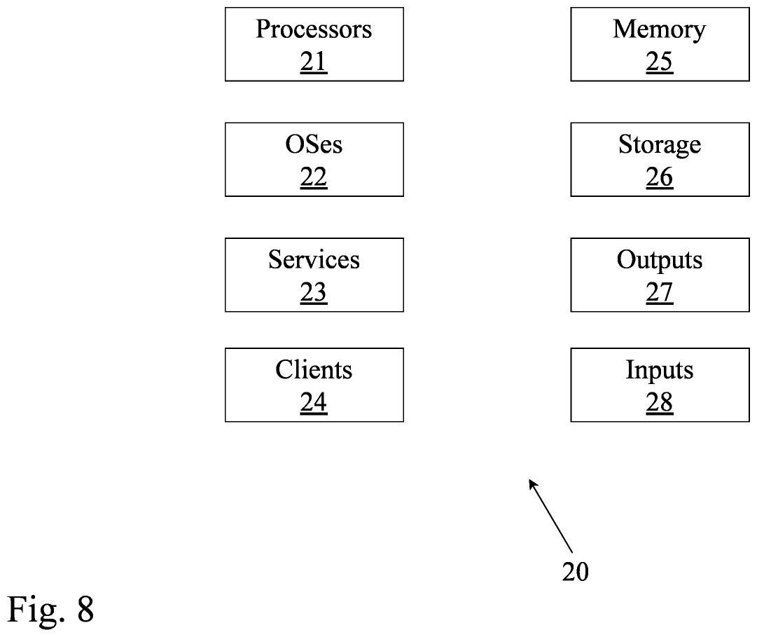

In some aspects, systems may be implemented on a standalone computing system. Referring now to FIG. 8, there is shown a block diagram depicting a typical exemplary architecture of one or more aspects or components thereof on a standalone computing system. Computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 7). Examples of storage devices 26 include flash memory, magnetic hard drive, CD-ROM, and/or the like.

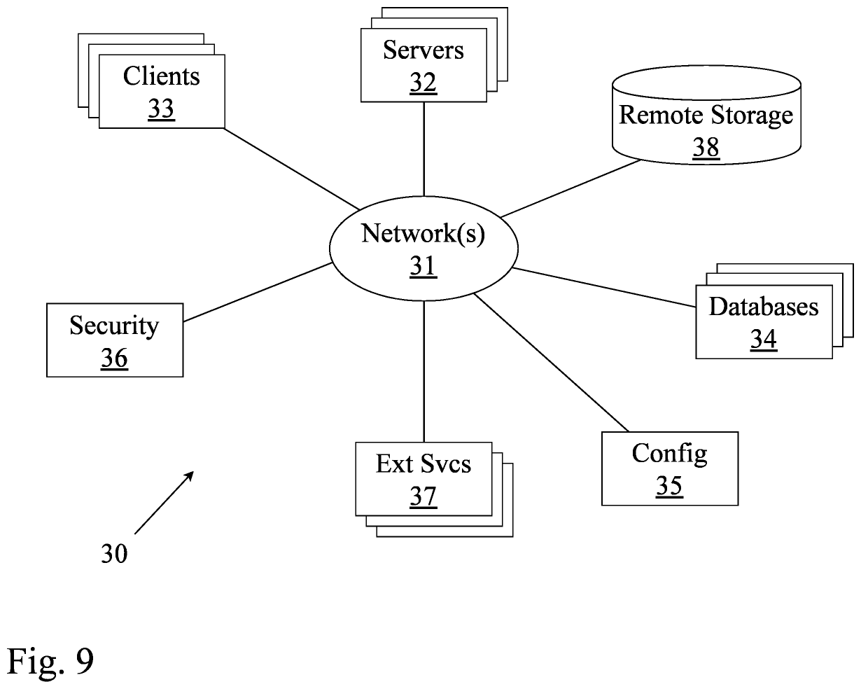

In some aspects, systems may be implemented on a distributed computing network, such as one having any number of clients and/or servers. Referring now to FIG. 9, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 8. In addition, any number of servers 32 may be provided for handling requests received from one or more clients 33. Clients 33 and servers 32 may communicate with one another via one or more electronic networks 31, which may be in various aspects any of the Internet, a wide area network, a mobile telephony network (such as CDMA or GSM cellular networks), a wireless network (such as WiFi, WiMAX,

LTE, and so forth), or a local area network (or indeed any network topology known in the art; the aspect does not prefer any one network topology over any other). Networks 31 may be implemented using any known network protocols, including for example wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored in a server system 32 in the cloud or on an external service 37 deployed on one or more of a particular enterprise's or user's premises.

In some aspects, clients 33 or servers 32 (or both) may make use of one or more specialized services or appliances that may be deployed locally or remotely across one or more networks 31. For example, one or more databases 34 may be used or referred to by one or more aspects. It should be understood by one having ordinary skill in the art that databases 34 may be arranged in a wide variety of architectures and using a wide variety of data access and manipulation means. For example, in various aspects one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with aspects without limitation, unless a specific security 36 or configuration system 35 or approach is specifically required by the description of any specific aspect.

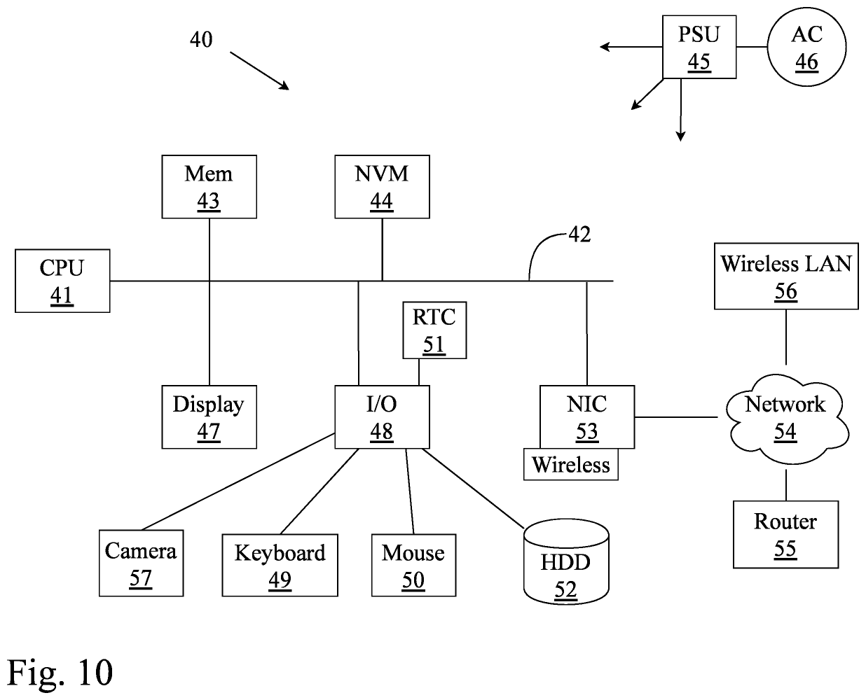

FIG. 10 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices)k67j8.

In various aspects, functionality for implementing systems or methods of various aspects may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various aspects described above. Accordingly, the present invention is defined by the claims and their equivalents.

What is claimed is:

1. A computing system for creation and expansion of high quality data set collections for training of machine learning algorithms via crowdsourced curation employing a cyber decision platform, the computing system comprising:
one or more hardware processors configured for:
scoring a data entry within a data set, wherein the score is calculated from a plurality of scoring metrics;
summing all of the data entry scores within the data set combining to form an overall reputation score;
flagging an erroneous data entry which may not be resolved through a machine learning algorithm;
comparing the overall reputation score with a numerical threshold for reputability;
sending the flagged erroneous data entry and the data sets not meeting the threshold for reputability to a verification queue;
storing the data sets that meet the threshold for reputability to a data store as a reputable data set collection;
receiving the flagged erroneous data entry and the data sets not meeting the threshold for reputability;
assigning the data in the verification queue to a data steward for human curation; and
sending the curated and resolved data back to the reputation scoring engine for an additional iteration.

2. The computing system of claim 1, wherein the one or more hardware processors are further configured for:
retrieving a reputable data set collection stored within the data store;
generating a synthetic data set from the reputable data set; and
merging the synthetic data with the reputable data set collection where the synthetic data set passes the threshold for reputability.

3. The computing system of claim 2, wherein the synthetic data set is generated by a generative adversarial network.

4. The computing system of claim 1, wherein the plurality of scoring metrics is associated with at least data quality, data provenance, or uncertainty and risks.

5. The computing system of claim 1, wherein the numerical threshold for reputability is based at least in part on the veracity of the dataset.

6. A computer-implemented method executed on a cyber decision platform for creation and expansion of high quality data set collections for training of machine learning algorithms via crowdsourced curation, the computer-implemented method comprising:
scoring a data entry within a data set, wherein the score is calculated from a plurality of scoring metrics;
summing all of the data entry scores within the data set combining to form an overall reputation score;
flagging an erroneous data entry which may not be resolved through the machine learning algorithm;
comparing the overall reputation score with a numerical threshold for reputability;
sending the flagged erroneous data entry and the data sets not meeting the threshold for reputability to a verification queue;
storing the data sets that meet the threshold for reputability to a data store;
assigning the data in the verification queue to a data steward for human curation; and
sending the curated data back for an additional iteration of the above process.

7. The computer-implemented method of claim 6, further comprising the steps of:
retrieving a data set collection stored within the data store;
generating a synthetic data set from the retrieved data set;
sending the synthetic data set for scoring based on the above process; and
merging the synthetic data with the reputable data set collection where the synthetic data set passes the threshold for reputability.

8. The computer-implemented method of claim 7, wherein the synthetic data set is generated by a generative adversarial network.

9. The computer-implemented method of claim 6, wherein the plurality of scoring metrics is associated with at least data quality, data provenance, or uncertainty and risks.

10. The computer-implemented method of claim 6, wherein the numerical threshold for reputability is based at least in part on the veracity of the dataset.

11. A system for creation and expansion of high quality data set collections for training of machine learning algorithms via crowdsourced curation employing a cyber decision platform, comprising one or more computers with executable instructions that, when executed, cause the system to:
score a data entry within a data set, wherein the score is calculated from a plurality of scoring metrics;
sum all of the data entry scores within the data set combining to form an overall reputation score;
flag an erroneous data entry which may not be resolved through a machine learning algorithm;
compare the overall reputation score with a numerical threshold for reputability;
sending the flagged erroneous data entry and the data sets not meeting the threshold for reputability to a verification queue;
store the data sets that meet the threshold for reputability to a data store as a reputable data set collection;
receive the flagged erroneous data entry and the data sets not meeting the threshold for reputability;
assign the data in the verification queue to a data steward for human curation; and
send the curated and resolved data back to the reputation scoring engine for an additional iteration.

12. The system of claim 11, further comprising the steps of:
retrieving a data set collection stored within the data store;
generating a synthetic data set from the retrieved data set;
sending the synthetic data set for scoring based on the above process; and
merging the synthetic data with the reputable data set collection where the synthetic data set passes the threshold for reputability.

13. The system of claim 12, wherein the synthetic data set is generated by a generative adversarial network.

14. The system of claim 11, wherein the plurality of scoring metrics is associated with at least data quality, data provenance, or uncertainty and risks.

15. The system of claim 11, wherein the numerical threshold for reputability is based at least in part on the veracity of the dataset.

16. Non-transitory, computer-readable storage media having computer-executable instruction embodied thereon that, when executed by one or more processors of a computing system employing a cyber decision platform for creation and expansion of high quality data set collections for training of machine learning algorithms via crowdsourced curation, cause the computing system to:
score a data entry within a data set, wherein the score is calculated from a plurality of scoring metrics;
sum all of the data entry scores within the data set combining to form an overall reputation score;
flag an erroneous data entry which may not be resolved through a machine learning algorithm;
compare the overall reputation score with a numerical threshold for reputability;
sending the flagged erroneous data entry and the data sets not meeting the threshold for reputability to a verification queue;
store the data sets that meet the threshold for reputability to a data store as a reputable data set collection;
receive the flagged erroneous data entry and the data sets not meeting the threshold for reputability;
assign the data in the verification queue to a data steward for human curation; and
send the curated and resolved data back to the reputation scoring engine for an additional iteration.

17. The non-transitory, computer-readable storage media of claim 16, further comprising the steps of:
retrieving a data set collection stored within the data store;
generating a synthetic data set from the retrieved data set;
sending the synthetic data set for scoring based on the above process; and
merging the synthetic data with the reputable data set collection where the synthetic data set passes the threshold for reputability

18. The non-transitory, computer-readable storage media of claim 17, wherein the synthetic data set is generated by a generative adversarial network.

19. The non-transitory, computer-readable storage media of claim 16, wherein the plurality of scoring metrics is associated with at least data quality, data provenance, or uncertainty and risks.

20. The non-transitory, computer-readable storage media of claim 16, wherein the numerical threshold for reputability is based at least in part on the veracity of the dataset.
